(19) United States
(12) Patent Application Publication
(10) Pub. No.: US 2018/0013463 A1
(43) Pub. Date: Jan. 11, 2018

(54) MOBILE PHONE CASE HAVING AN ANGLE ADJUSTABLE PHONE HANGER RING

(71) Applicant: Bok Jib JEON, Bucheon-si (KR)

(72) Inventor: Bok Jib JEON, Bucheon-si (KR)

(21) Appl. No.: 15/231,068

(22) Filed: Aug. 8, 2016

(30) Foreign Application Priority Data
Jul. 7, 2016 (KR) 10-2016-0086195

(51) Int. Cl. H04M 1/02

(52) U.S. Cl. CPC H04B 1/3888; H04M 1/0202

(57) ABSTRACT

The present invention provides a mobile phone case 1 having an angle adjustable phone hanger ring 400 configured to protect the mobile phone 10 as an inherent function, and simply and stably grip and carry the mobile phone 10 during carrying by using a ring type hanger integrally provided in a back surface of the mobile phone 10, thereby allowing a user to use the mobile phone 10 with being hung for viewing a moving image or TV broadcasting, and in particular, adjust and fix the mobile phone 10 at different angles desired by the user during using the mobile phone with being hung, and thereby more improving efficiencies in use of the hanger.

### RELATED APPLICATIONS

This application claims priority to Korean Patent Application No. 10-2016-0086195, filed on Jul. 7, 2016 in the Korean Intellectual Property Office, the entire disclosure of which is incorporated herein by reference.

### BACKGROUND OF THE INVENTION

### 1. Field of the Invention

The present invention relates to a mobile phone case, and more specifically, to a mobile phone case having an angle adjustable phone hanger ring which is mounted on a back surface of a mobile phone so as to protect the mobile phone and allow a user to simply use the mobile phone as necessary without a separate hanger when viewing a moving image or television broadcasting by using the hanger.

### 2. Description of the Related Art

Generally, mobile phones are the most common communication means, and place in the ranks of indispensable necessities from young children to the elderly.

In addition, as such the mobile phone, a so-called smart phone equipped with various functions due to a development of industrial techniques has been widely distributed. Such the smart phone plays a role of the communication means for calling, texting, and the like, and functions performing as a camera, an MP3 player, a video player, and a television are being increased day by day. Accordingly, a price of the smart phone is also increased, and considerable costs for repairing at the time of damage have been spent.

Thereby, users typically use a separate mobile phone case for protecting an expensive smart phone, so as to protect the smart phone from scratches, abrasive wearing, or a damage due to an impact.

Further, in recent years, a variety of such the mobile phone cases is being increased. Typically, the mobile phone case is formed in a wallet form having a plurality of card housing spaces, such that it is possible to simply put credit cards or a transportation card into the space with an increased function applied thereto.

However, the above-described conventional mobile phone case has a purpose to protect the mobile phone or increase convenience upon carrying. Therefore, there is a necessity to provide a separate hanger when viewing the moving image or TV broadcasting on the smart phone, for example, which may cause a limitation in functions of the mobile phone during using the same.

Further, in recent years, attach-installation type hangers are used to provide a support function to such the mobile phone. However, such the hangers have problems such as a decrease in an attachment force when using it for a long period time, and a deterioration in an appearance due to an adhesive which is adhered and remained on a back surface of the case if the hanger is removed therefrom due to the decreased attachment force.

There are many techniques for protecting the mobile phone, for example, a mobile phone case disclosed in Korean Patent Registration No. 10-1635411, a mobile phone case having a multi-stage elevating means disclosed in Korean Patent Laid-Open Publication No. 10-2016-0069877, and a mobile phone hanger disclosed in Korean Utility Model Laid-Open Publication No. 20-2015-0002726.

### SUMMARY OF THE INVENTION

In consideration of the above-mentioned circumstances, it is an object of the present invention to provide a mobile phone case having an angle adjustable phone hanger ring configured to protect the mobile phone as an inherent function, and simply and stably grip and carry the mobile phone during carrying by using a ring type hanger integrally provided in a back surface of the mobile phone, as well as allow a user to use the mobile phone with being hung for viewing a moving image or TV broadcasting, and in particular, adjust and fix the mobile phone at different angles desired by the user during using the mobile phone with being hung, and thereby more improving efficiencies in use of the hanger.

In order to achieve the above-described object, according to the present invention, there is provided a mobile phone case having an angle adjustable phone hanger ring, including: a case body which is made of a resin and includes a back plate and edge portions formed at edges of the back plate, wherein the back plate has a protrusion part formed thereon by protruding to an outside, the protrusion part has a mounting recess concavely formed therein with being opened to the outside, and the mounting recess has a fixed hole formed in a center thereof, and a latched groove formed in an inner surface thereof around the fixed hole; an axis mounting plate which is placed in the mounting recess of the case body and includes a fixture insertion hole which is formed in a longitudinal direction at a center thereof having a step and has a locked part formed at an outer end portion thereof, a semicircular-shaped axis mounting groove formed on both sides of the fixture insertion hole in a lateral direction, a pin insertion groove formed on one side thereof in a direction orthogonal to the axis mounting groove, and a plurality of coupling protrusions formed on an outer circumference in a circumferential direction thereof; a fixture which is configured to be inserted into the fixture insertion hole and includes a locking part formed at an outer end portion thereof to be locked to and supported by the locked part, an elastic groove formed in an inner end portion thereof with being opened rearward, and an elastic fixing part formed around the inner end portion to be fixed to the fixed hole, so as to couple the case body and the axis mounting plate with each other through the elastic fixing part fixed to the fixed hole with being inserted into the fixture insertion hole; a hanger ring including an axis part formed at one end thereof to be mounted in the axis mounting groove; an elastic fixture configured to be housed in the pin insertion groove of the axis mounting plate; and a cover which is configured to cover one side of the axis mounting plate in a cap shape with being opened rearward, and includes an axis part closing groove formed in a bottom surface thereof with being opened on both sides to cover the axis part, and a coupling groove formed in a rear inner circumference thereof to be coupled with the coupling protrusions of the axis mounting plate.

According to the mobile phone case of the present invention having the above-described configuration, since the hanger is integrally provided in the back surface of the mobile phone case, it is possible to protect the mobile phone which is the same inherent function as the conventional mobile phone case, and allow a user to use the mobile phone with being hung for viewing a moving image or TV broadcasting through the hanger, and thereby more improving efficiencies in use.

In addition, according to the mobile phone case of the present invention, it is possible to provide effects of simply and stably holding and carrying the mobile phone during carrying through the hanger ring of the hanger by inserting a finger into the hanger ring.

Further, according to the mobile phone case of the present invention, it is possible to adjust the mobile phone at different angles through the plurality of elastic support teeth formed on the outer circumference of the axis part and the elastic fixture elastically engaged to the elastic support teeth. Thereby, it is possible to provide effects of adjusting and fixing the mobile phone at an angle desired by the user when viewing the moving image or TV broadcasting, and maintaining the mobile phone at the adjusted and fixed angle, thus to improving efficiencies in use of the hanger.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view illustrating a mobile phone case having an angle adjustable phone hanger ring according to the present invention;

FIG. 2 is a perspective view illustrating the assembled mobile phone case having an angle adjustable phone hanger ring according to the present invention;

FIG. 3 is a cross-sectional view illustrating the assembled mobile phone case having an angle adjustable phone hanger ring according to the present invention;

FIG. 4 is an exploded perspective view illustrating major components of the mobile phone case having an angle adjustable phone hanger ring according to the present invention;

FIG. 5 is a cross-sectional view illustrating the mobile phone case having an angle adjustable phone hanger ring according to the present invention with being installed;

FIG. 6 is a perspective view illustrating the mobile phone case having an angle adjustable phone hanger ring according to the present invention with being rotated as viewed from a top;

FIG. 7 is a cross-sectional view describing a state of adjusting an angle of the mobile phone case having an angle adjustable phone hanger ring according to the present invention; and

FIG. 8 is schematic views describing states of using the mobile phone case having an angle adjustable phone hanger ring according to the present invention.

### DETAILED DESCRIPTION OF THE INVENTION

Terms or words used in the specification and claims should not be construed as limited to a conventional or lexical meaning, and should be understood as appropriate notions by the inventor based on that he/she is able to define terms to describe his/her invention in the best way to be seen by others.

Therefore, embodiments and drawings described herein are the most preferable embodiment of the present invention and not exhaustive in terms of the technical idea of the present invention, and it will be understood that various modifications and equivalents may be made to take the place of the embodiments at the application point of the present invention.

Hereinafter, preferable embodiments of the present invention will be described with reference to the accompanying drawings.

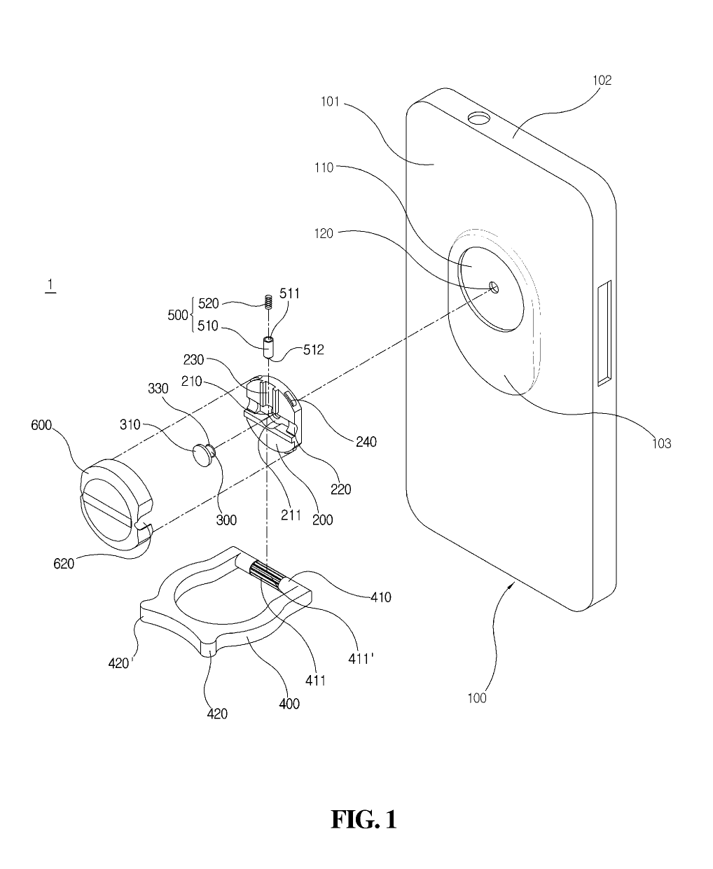

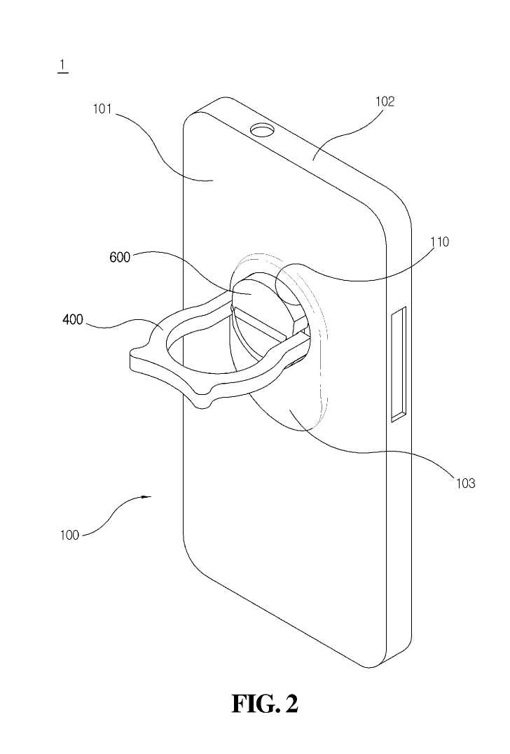

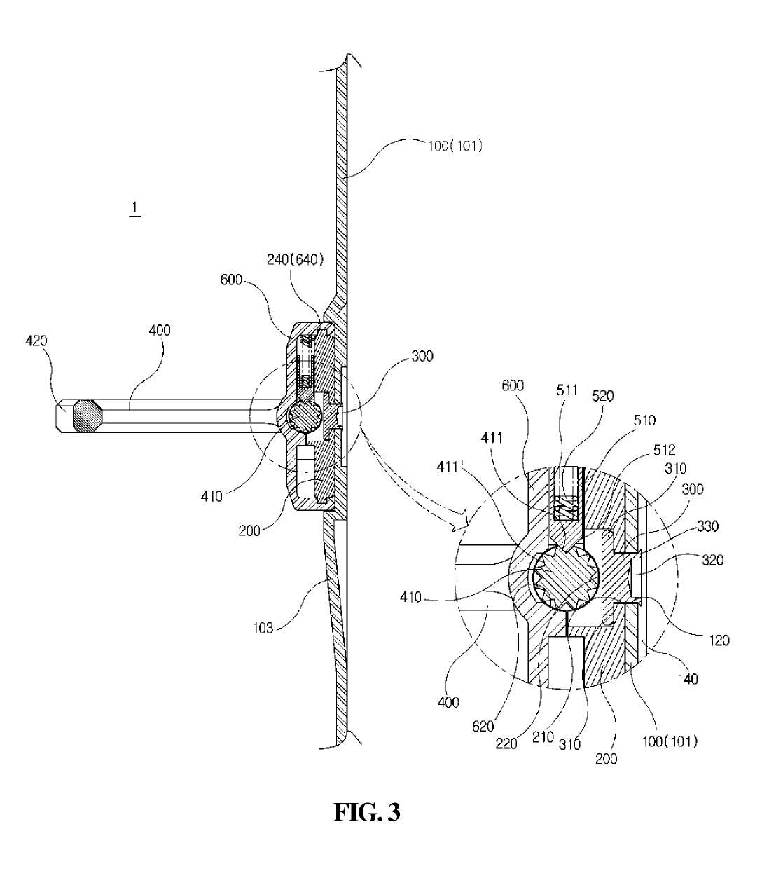

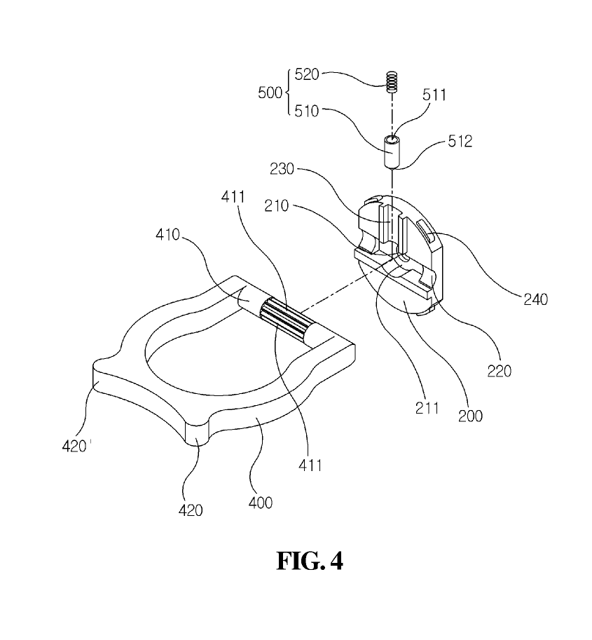

FIG. 1 is an exploded perspective view illustrating a mobile phone case having an angle adjustable phone hanger ring according to the present invention, FIG. 2 is a perspective view illustrating the assembled mobile phone case having an angle adjustable phone hanger ring according to the present invention, FIG. 3 is a cross-sectional view illustrating the assembled mobile phone case having an angle adjustable phone hanger ring according to the present invention, and FIG. 4 is an exploded perspective view illustrating major components of the mobile phone case having an angle adjustable phone hanger ring according to the present invention

As illustrated in FIGS. 1 to 4, a mobile phone case 1 having an angle adjustable phone hanger ring includes a case body 100 forming an appearance of the mobile phone case, an axis mounting plate 200, a fixture 300, a hanger ring 400, an elastic fixture 500, and a cover 600, which are integrally provided in a back surface of the mobile phone case 1 to form an angle adjustable phone hanger of the present invention.

Herein, the case body 100 is made of a soft or hard resin material, and is formed so as to surround the back surface and edge portions of the mobile phone. The case body 100 includes a back plate 101 disposed in a state of being closely contacted with the back surface of the mobile phone to protect the same, and edge portions 102 integrally formed with edges of the back plate 101 to surround and protect the edge portions of the mobile phone.

In this case, in the case body 100, the back plate 101 has a protrusion part 103 formed thereon by protruding to an outside (hereinafter, referred to as a front corresponding to a left side in the drawings), the protrusion part 103 has a mounting recess 110 concavely formed therein with being opened to the outside, and the mounting recess 110 has a fixed hole 120 formed in a center thereof.

In addition, the back plate 101 has a penetrated type latched groove 140 formed in an inner (hereinafter, referred to as a rear corresponding to a right side in the drawings) surface thereof so as to enlarge around the fixed hole 120 while having a step with the fixed hole 120.

The axis mounting plate 200 is formed so as to be placed and housed in the mounting recess 110 of the case body 100, and has upper and lower portions forming outer circumferences and side portions formed in a cut plate shape. Herein the axis mounting plate 200 has an outer diameter of the outer circumferences slightly smaller than an inner diameter of the mounting recess 110.

The axis mounting plate 200 includes a fixture insertion hole 210 which is formed in a longitudinal direction at a center thereof to be communicated with the fixed hole 120 and has a locked part 211 formed at an outer end portion thereof having a larger diameter than the fixture insertion hole 210 so as to have a step therewith.

In addition, the axis mounting plate 200 includes a semicircular-shaped axis mounting groove 220 formed on both sides of the fixture insertion hole 210 in a lateral direction.

Further, the axis mounting plate 200 includes a pin insertion groove 230 formed on one side thereof in a direction orthogonal to the axis mounting groove 220, into which the elastic fixture 500 is inserted as described below.

Furthermore, the axis mounting plate 200 includes a plurality of coupling protrusions 240 formed on an outer circumference in a circumferential direction thereof.

The fixture 300 is configured to be inserted into the fixture insertion hole 210 so as to fix the axis mounting plate 200 to the case body 100 while allowing the axis mounting plate 200 to be rotated, and includes a locking part 310 formed at an outer end portion thereof in a disc shape to be locked to and supported by the locked part 211.

In addition, the fixture 300 includes an elastic groove 320 formed in an inner end portion thereof with being opened rearward.

Further, the fixture 300 includes an elastic fixing part 330 formed around the inner end portion thereof in a protruding shape.

That is, the fixture 300 is inserted into the fixed hole 120 through the fixture insertion hole 210 of the axis mounting plate 200 placed in the mounting recess 110, and the elastic fixing part 330 formed around the inner end portion thereof is latched to and supported by the latched groove 140 in the vicinity of the fixed hole 120 of the case body 100 on the rear side, so as to couple the case body 100 and the axis mounting plate 200 with each other. The axis mounting plate 200 is configured to be rotated about the fixture 300 as an axis.

Meanwhile, during the fixture 300 passes through the fixture insertion hole 210 and fixed hole 120, the elastic fixing part 330 is configured to protrude rearward from the fixture insertion hole 210 and the fixed hole 120. In this case, the elastic fixing part 330 is elastically deformed while a prescribed elastic energy is stored in the elastic groove 320 so as to be inserted into the fixture insertion hole 210 and the fixed hole 120, and is returned to an original state due to the elastic energy stored in the elastic groove 320 so as to be latched to and supported by the latched groove 140 when being completely inserted.

The hanger ring 400 is formed in a “ring” shape whose center is penetrated, and is configured to so as to be mounted in the axis mounting grooves 220 on the both sides of the axis mounting plate 200.

In this case, the hanger ring 400 includes an axis part 410 formed at one end thereof in a circular rod shape to be mounted in the axis mounting groove 220.

Herein, the axis part 410 includes elastic support teeth 411 and 411′. The elastic support teeth 411 and 411′ are continuously formed on a middle outer circumference of the axis part 410 in a sawtooth shape, and are formed on both sides thereof from the center in the longitudinal direction with a constant width, while having a width capable of preventing an interference with the axis mounting groove 220.

In addition, the hanger ring 400 includes a pair of support parts 420 and 420′ formed at an end opposite to the axis part 410 by protruding on both sides in order to stably support the mobile phone at the time supporting it on a table surface, or the like.

The elastic fixture 500 is configured to be housed in the pin insertion groove 230 of the axis mounting plate 200 to inhibit a rotation of the hanger ring 400. First, the elastic fixture 500 includes an angle fixing pin 510 having a spring housing hole 511 formed in an upper end portion thereof, and a conical engage part 512 formed at a lower end thereof to be engaged to and elastically supported by any one of the elastic support teeth 411 and 411′.

In addition, the elastic fixture 500 is provided with a spring 520. One end of the spring 520 is housed in the spring housing hole 511 of the angle fixing pin 510 and the other end thereof is elastically supported by an inner circumference of the cover 600 with being in contact therewith.

That is, the elastic fixture 500 is configured to normally press the angle fixing pin 510 toward the elastic support teeth 411 and 411′ by an elastic force of the spring 520 so as to maintain the hanger ring 400 at a desired angle. In this case, the conical engage part 512 of the angle fixing pin 510 is normally supported by any one of the elastic support teeth 411 and 411′ of the hanger ring 400 with being engaged thereto.

The cover 600 is configured to cover one side of the axis mounting plate 200 in the same cap shape as the axis mounting plate 200 with being opened rearward to form a space therein, and has an outer diameter smaller than the inner diameter of the mounting recess 110 of the case body 100. First, the cover 600 includes an axis part closing groove 620 formed in a bottom surface thereof with being opened on both sides to cover the axis part 410 mounted corresponding to the axis mounting groove 220 of the axis mounting plate 200.

In addition, the cover 600 includes a coupling groove 640 formed in a rear inner circumference thereof to be elastically coupled with the coupling protrusions 240 of the axis mounting plate 200. In this case, for a smooth insertion of the coupling protrusions 240, it is preferable that the cover 600 is formed in an inclination shape in which the rear inner edge thereof is enlarged forward.

That is, the cover 600 covers and closes the axis mounting plate 200 in a state in which the coupling protrusions 240 of the 200 is coupled with the coupling groove 640, and the axis part closing groove 620 covers and closes the axis part 410 of the hanger ring 400 housed in the axis mounting groove 220, while the upper end of the spring 520 of the elastic fixture 500 is elastically supported ty the inner circumference of the cover 600 and the outer circumference thereof is housed in the mounting recess 110 of the case body 100.

Herein, in a case of closing the axis mounting plate 200 by covering the cover 600 as described above, the axis mounting groove 220 of the axis mounting plate 200 and the axis part 410 of the hanger ring 400 may have larger sizes than the outer diameter of the axis part 410 having a prescribed clearance so as to prevent an interference with the axis part 410 occurred during rotation thereof.

Hereinafter, an operation of the mobile phone case having an angle adjustable phone hanger ring configured as described above will be described in detail.

First, it is preferable that the mobile phone case 1 having an angle adjustable phone hanger ring according to the present invention is produced and sold in a state in which the axis mounting plate 200, the fixture 300, the hanger ring 400, the elastic fixture 500 and the cover 600 are assembled into the case body 100 during manufacturing.

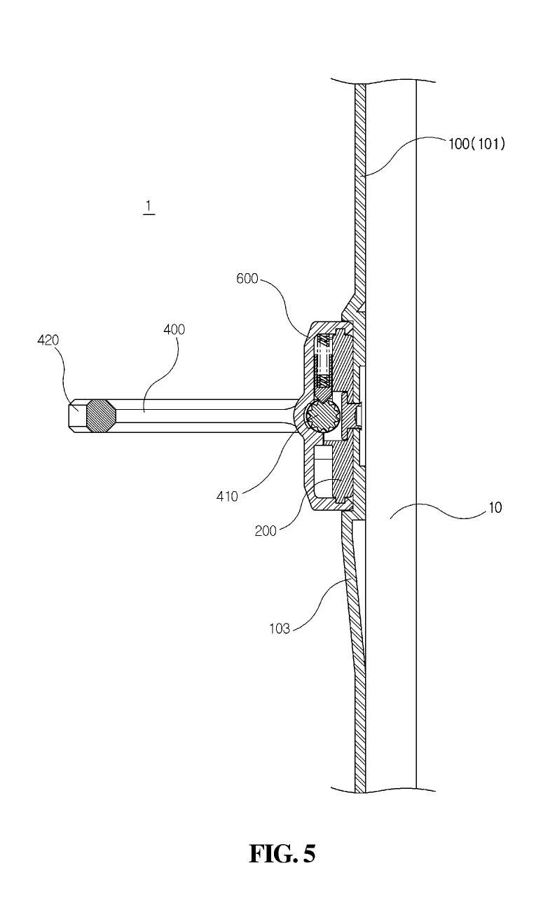

Thereby, as illustrated in FIG. 5, the mobile phone case 1 having an angle adjustable phone hanger ring may surround the back surface and edge portions of the mobile phone as the conventional mobile phone case to protect the mobile phone from scratches, abrasive wearing, or a damage due to an impact.

In addition, the mobile phone case 1 having an angle adjustable phone hanger ring may provide various functions. First, although not illustrated in the drawings, when a user grips and carries a mobile phone 10 during carrying, the user may grip the mobile phone 10 in a state in which any one finger is inserted into the hanger ring 400. When griping the mobile phone as described above, it is possible to grip the mobile phone 10 in both manners of conventionally gripping using a palm and hanging and griping using the finger, and thereby stably grip the mobile phone 10 while preventing a damage occurred due to dropping the same during carrying.

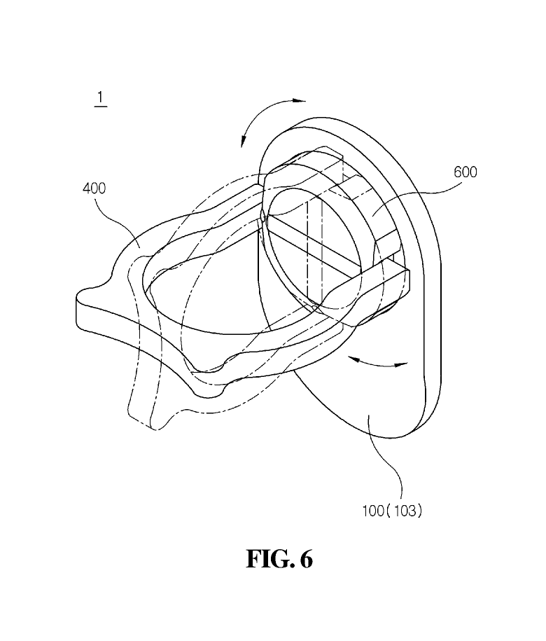

In addition, during such the carrying, a rotational angle of the mobile phone case 1 according to the present invention may be adjusted. When rotating the hanger ring 400 as illustrated in FIG. 6, the hanger ring 400 and the axis mounting plate 200 and the cover 600 which are coupled therewith may be rotated about the fixture 300 as an axis, such that the user may hang the mobile phone case 1 in different directions.

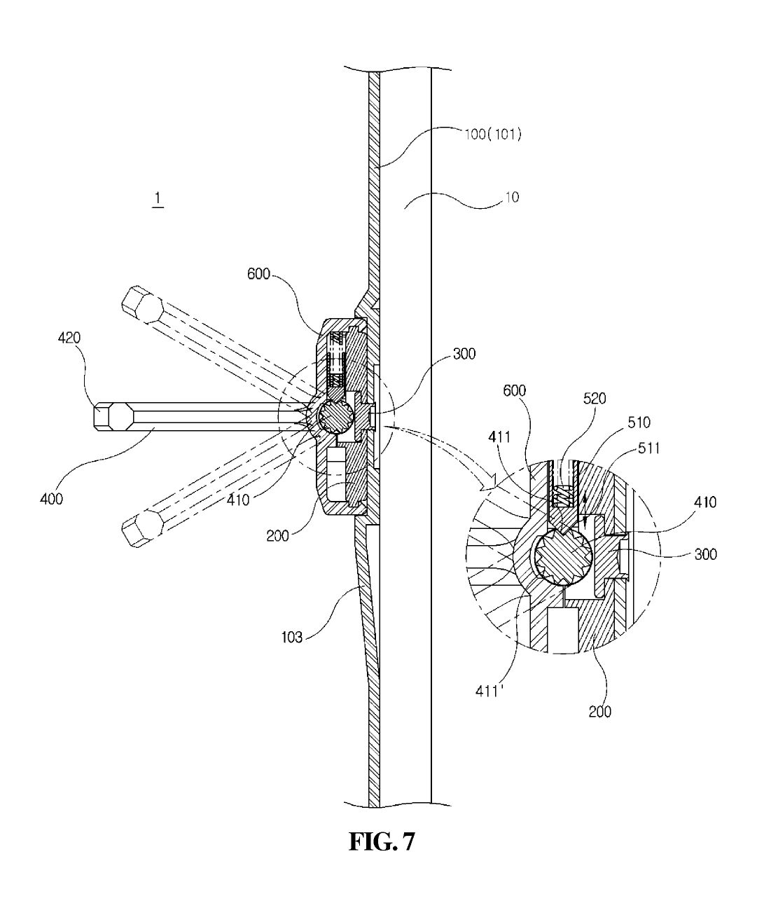

Further, the mobile phone case 1 according to the present invention may be simply installed at the most suitable angle for viewing the image by the user using the angle adjustable hanger ring 400 integrally provided in the case body 100 without using a separate hanger for a mobile phone when viewing the moving image or TV broadcasting, which may be performed by an operation of the hanger ring 400 as illustrated in FIG. 7.

That is, the user may rotate the hanger ring 400 about the axis part 410 of the hanger ring 400 as an axis while using the axis mounting groove 220 of the axis mounting plate 200 and the axis part closing groove 620 of the cover 600 as an axis seat.

In this case, the elastic fixture 500 is normally elastically supported by any one of the elastic support teeth 411 and 411′ formed on the axis part 410 of the hanger ring 400, such that the angle fixing pin 510 of the elastic fixture 500 normally presses toward the elastic support teeth 411 and 411′ by the elastic force of the spring 520. Thereby, the conical engage part 512 of the angle fixing pin 510 may be engaged to the elastic support tooth 411 or 411′ corresponding to an angel adjusted by the user to fix the hanger ring 400 at the adjusted angle.

That is, during adjusting the angle as described above, the conical engage part 512 of the angle fixing pin 510 and the elastic support tooth 411 or 411′ of the hanger ring 400 is in contact with each other through inclined surfaces thereof. Therefore, if the user forcedly rotates the hanger ring 400, the angle fixing pin 510 is retreated upward against the elastic force of the spring 520 while an elastic energy is stored therein by the force applied during acting frictional sliding on the respective inclined surfaces, and if an external force from the user is removed, the angle fixing pin 510 may protrude downward by the elastic energy stored in the spring 520 to be elastically engaged and fixed to the elastic support tooth 411 or 411′

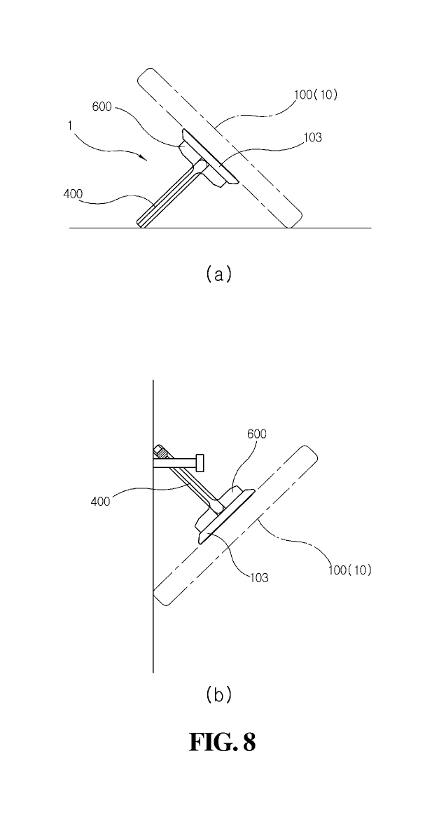

Meanwhile, the mobile phone case 1 of the present invention allows the user to view the moving image or TV broadcasting by adjusting and fixing the above-described hanger ring 400 at an angle desired by the user. Of course, due to maintaining the mobile phone at such the angle, the mobile phone 10 may be hung on a table as illustrated in FIG. 8 panel (a), and in particular, the mobile phone 10 may be maintained at the desired angle with being hung on a nail studded on a wall using the hanger ring 400 as illustrated in FIG. 8 panel (b) to allow the user to easily and conveniently view the image displayed thereon.

Further, the support parts 420 and 420′ formed in the hanger ring 400 may stably support the mobile phone 10 with being supported on a surface of the table or the like, during supporting the hanger ring 400.

According to the mobile phone case having an angle adjustable phone hanger ring of the present invention having the above-described configuration, it is possible to surround and protect the mobile phone using the mobile phone case, and adjust and fix the angle of the hanger ring which may be selectively rotated, and thereby stably griping and carrying the mobile phone during carrying. In particular, when using the mobile phone with being hung for viewing the moving image or TV broadcasting, the mobile phone may be adjusted at different angles according to the angle desired by the user by operating the hanger ring without using a separate hanger for the mobile phone, and thereby improving efficiencies in use of the hanger.

Further, according to the mobile phone case having an angle adjustable phone hanger ring of the present invention, since the hanger ring used as a hanger is integrally provided in the mobile phone case, it is possible to prevent the hanger ring from being removed even when using it for a long period time.

While the present invention has been described with reference to the preferred embodiments, it will be understood by those skilled in the related art that various modifications and variations may be made therein without departing from the scope of the present invention as defined by the appended claims.

What is claimed is:

1. A mobile phone case having an angle adjustable phone hanger ring, comprising:
a case body 100 which is made of a resin and includes a back plate 101 and edge portions 102 formed at edges of the back plate 101, wherein the back plate 101 has a protrusion part 103 formed thereon by protruding to an outside, the protrusion part 103 has a mounting recess 110 concavely formed therein with being opened to the outside, and the mounting recess 110 has a fixed hole 120 formed in a center thereof, and a latched groove 140 formed in an inner surface thereof around the fixed hole 120;
an axis mounting plate 200 which is placed in the mounting recess 110 of the case body 100 and includes a fixture insertion hole 210 which is formed in a longitudinal direction at a center thereof having a step and has a locked part 211 formed at an outer end portion thereof, a semicircular-shaped axis mounting groove 220 formed on both sides of the fixture insertion hole 210 in a lateral direction, a pin insertion groove 230 formed on one side thereof in a direction orthogonal to the axis mounting groove 220, and a plurality of coupling protrusions 240 formed on an outer circumference in a circumferential direction thereof;
a fixture 300 which is configured to be inserted into the fixture insertion hole 210 and includes a locking part 310 formed at an outer end portion thereof to be locked to and supported by the locked part 211, an elastic groove 320 formed in an inner end portion thereof with being opened rearward, and an elastic fixing part 330 formed around the inner end portion to be fixed to the fixed hole 120, so as to couple the case body 100 and the axis mounting plate 200 with each other through the elastic fixing part 330 fixed to the fixed hole 120 with being inserted into the fixture insertion hole 210;
a hanger ring 400 including an axis part 410 formed at one end thereof to be mounted in the axis mounting groove 220;
an elastic fixture 500 configured to be housed in the pin insertion groove 230 of the axis mounting plate 200; and
a cover 600 which is configured to cover one side of the axis mounting plate 200 in a cap shape with being opened rearward, and includes an axis part closing groove 620 formed in a bottom surface thereof with being opened on both sides to cover the axis part 410, and a coupling groove 640 formed in a rear inner circumference thereof to be coupled with the coupling protrusions 240 of the axis mounting plate 200.

2. The mobile phone case according to claim 1, wherein the axis part 410 of the hanger ring 400 is formed in a circular rod shape and includes elastic support teeth 411 and 411′ continuously formed on a middle outer circumference thereof in a sawtooth shape, and
the elastic fixture 500 includes: an angle fixing pin 510 having a spring housing hole 511 formed in an upper end portion thereof, and a conical engage part 512 formed at a lower end thereof to be engaged to and elastically supported by the elastic support tooth 411 or 411′; and
a spring 520 whose one end is housed in the spring housing hole 511 and the other end is elastically supported by an inner circumference of the cover 600 with being in contact therewith to normally press the angle fixing pin 510 toward the elastic support teeth 411 and 411′ so as to maintain at an angle of the hanger ring 400.

3. The mobile phone case according to claim 1, wherein the hanger ring 400 further includes support parts 420 and 420′ formed at an end opposite to the axis part 410 by protruding on both sides.
